(19) United States
(12) Patent Application Publication
(10) Pub. No.: US 2006/0170118 A1
(43) Pub. Date: Aug. 3, 2006

(54) Production of benzyllithium, benzylsodium, and polyphenylene paradimethylene

(76) Inventor: Christian Everett, Springfield, IL (US)

Correspondence Address: CHRISTIAN EVERETT, 483 SOUTH KIRKWOOD ROAD, # 228, SAINT LOUIS, MO, 63122, US

(21) Appl. No.: 11/049,091

(22) Filed: Feb. 3, 2005

(51) Int. Cl. C07F 1/02; C07F 1/04; C07F 1/06

(52) U.S. Cl. 260/665 R

(57) ABSTRACT

A process for producing benzyllithium, benzylsodium and polyphenylene paradimethylene and analogs comprising dissolving toluene in an aprotic polar solvent in which toluene is more acidic than water, such as DMSO, under an inert atmosphere, such as argon, adding an alkali metal hydroxide, such as lithium or sodium hydroxide, to form the alkali metal anion of the benzyl cation and water then removing the solvent and water to obtain the solid alkali metal alpha-carbon toluene compound, which is best stored under hexane. This process also relating to toluene analogs such as parachloro toluene which thereby yields parachloro alkali metal alpha-carbon toluene which is then polymerized by heating with a suitable high-boiling solvent, such as dibutyl ether or dimethoxy ethane in the presence of a copper catalyst, such as copper sulfate or finely divided copper metal at approximately 170C for 5 hours to form polyphenylene paradimethylene. This process having the advantage of using alkali metal hydroxides instead of elemental alkali metals, a reaction occurring at ordinary temperatures, and a lower cost of the product. This process also allowing the economical production of polyphenylene paradimethylene which is not currently being manufactured.

### BACKGROUND

1. Field of Invention

This invention relates to the production of alkali-metalated alpha toluenes, their analogs and polymers.

2. Description of Prior Art

Currently benzyllithium is produced by the reaction of toluene with butyllithium, which is itself produced by the reaction of butyl bromide with elemental lithium at −80C. Benzylsodium has been produced by the reaction of chlorotoluene and sodium and rearranging the product to form the title compound (U.S. Pat. No. 4,084,061). The disadvantages of these processes are the difficulties of working with elemental alkali metals, low reaction temperatures and less than quantitative yields. Also there is currently no method for producing polyphenylene paradimethylene.

### OBJECTS AND ADVANTAGES

Several objects and advantages of the present invention are:

(A) Increased yield of product

(B) Less waste-no side reactions

(C) Uses low cost alkali metal hydroxides

(D) Reaction occurs at ordinary temperatures

(E) Cost of product will be less than by existing methods

### SUMMARY

In accordance with the present invention a process to produce compounds of toluene where one hydrogen of the methyl group is replaced by an alkali metal atom, analogs of these compounds and their polymers by dissolving toluene in an aprotic polar solvent in which the acidity of toluene is greater than that of water, such as DMSO, under an inert atmosphere, such as argon, adding an alkali metal hydroxide, such as lithium or sodium hydroxide to produce benzyllithium or benzylsodium and an equimolar quantity of water, then removing the solvent and water under reduced pressure, whereby the solid alpha-metalated toluene is obtained.

### DESCRIPTION

The ability of an alkali metal to replace hydrogen in a compound is a function of the acidity of the compounds. This acidity is described by the term pKa. Sodium, as typical of alkali metals, will disproportionate from a less acidic compound to a more acidic compound. In DMSO, the pKa of toluene is 28.3 and the pKa of water is 29.2 (acidity increases as pKa decreases). The acidity of compounds in aprotic solvents has no relation to their acidity in protic solvents, these may by greater or lesser depending on the compound. For example, in protic solvents water has a pKa of 15 and toluene has a pKa of 35. The benzyl cation has five resonance structures which allow it to delocalize the charge of the alkali metal ion, ortho, ortho, para, alpha-1,3,5 cyclohexatriene and alpha-2,4,6 cyclohexatriene, while the hydroxyl ion has dipole inductive effect. In aprotic solvents resonance delocalization is enhanced, while dipole inductive effect is decreased, thus a procedural advantage is realized by using aprotic solvents to perform the reaction.

### Example 1

One tenth mole of toluene (9.2 grams) is dissolved in 100 ccs of DMSO at 25C under an inert atmosphere of argon. One tenth mole of lithium hydroxide is added to form one tenth mole of benzyllithium (11.4 grams) and one tenth mole of water (1.8 grams). The water and DMSO are removed under reduced pressure (10 mm Hg) leaving the solid benzyllithium which is best stored in hexane.

### Example 2

One tenth mole of ethylbenzene (10.6 grams) is dissolved in 100 ccs of DMSO at 25C under an inert atmosphere of propane. One tenth mole of sodium hydroxide (4.0 grams) is added to form one tenth mole of alpha-sodium ethylbenzene (12.8 grams) and one tenth mole of water (1.8 grams). The water and DMSO are removed under reduced pressure (10 mm Hg) leaving the solid alpha-sodium ethylbenzene which is best stored under hexane.

### Example 3

One tenth mole of isopropylbenzene (12.0 grams) is dissolved in 100 ccs of DMSO at 25C under an inert atmosphere of argon. One tenth mole of potassium hydroxide (4.0 grams) is added to form one tenth mole of alpha-potassium isopropylbenzene (15.9 grams) and one tenth mole of water (1.8 grams). The water and DMSO are removed under reduced pressure (10 mm Hg) leaving the solid alpha-potassium isopropylbenzene which is somewhat insoluble in hexane. The solubility can be improved by the addition of crown ethers, such as crown 6 ether, but these ethers will be gradually attacked by alpha-potassium isopropylbenzene.

### Example 4

One tenth mole of parachloro toluene (11.6 grams) is dissolved in 100 ccs of DMSO at 25C under an inert atmosphere of argon. One tenth mole of sodium hydroxide (4.0 grams) is added to form one tenth mole of parachloro benzylsodium (13.8 grams) and one tenth mole of water (1.8 grams). The water and DMSO are removed under reduced pressure (10 mm Hg), leaving the solid parachloro benzylsodium which is dissolved in a suitable high boiling solvent such as dibutyl ether or dimethoxy ethane in the presence of a copper catalyst such as copper sulfate or finely divided copper metal and heated to 170C for 5 hours to form polyphenylene paradimethylene and sodium chloride.

### CONCLUSION, RAMAFICATION AND SCOPE

Accordingly, the reader will see the production of benzyllithium and related compounds by using alkali metal hydroxides in aprotic polar solvents is more convenient than current methods.

Furthermore, the process has additional advantages in that
yields are increased
byproducts and waste are reduced
uses less costly, more manageable alkali metal hydroxides
sole byproduct for benzyl alkali metal compounds is water, and for polyphenylene paradimethylene is sodium chloride, reducing environmental concerns.

Although the process contains specifities, these should not be construed as limiting the scope of the invention, but merely providing illustrations of some of the presently preferred embodiments of the invention. For example, other inert gasses may be used, and other solvents may be used. Thus the scope of the invention should be determined by the appended claims and their legal equivalents rather than by the examples given.

I claim:

1. A method for producing benzyllithium, benzylsodium and benzylpotassium comprising The steps of:
A. Dissolving toluene in an aprotic polar solvent in which the acidity of toluene is greater than that of water, such as DMSO, at normal temperatures, under an inert atmosphere, such as argon.
B. Adding an alkali metal hydroxide, such as lithium, sodium or potassium hydroxide to form the alpha-carbon metalated toluene compound and an equimolar quantity of water.
C. Removing the water and solvent under reduced pressure, such as 10 mm Hg to obtain the solid alpha-carbon metalated toluene compound, which is best stored under hexane.

2. A method for producing analogs of benzyllithium, benzylsodium and benzylpotassium comprising the steps of:
A: Dissolving a compound containing a benzyl moiety, where the moiety has at least one hydrogen on the alpha carbon, such as ethylbenzene, isopropylbenzene, and diphenyl methane, in an aprotic polar solvent in which the acidity of the toluene analog compound is greater than that of water, such as DMSO, at normal temperatures, under an inert atmosphere, such as argon.
B: Adding an alkali metal hydroxide, such as lithium, sodium or potassium hydroxide to form the alpha-carbon metalated toluene analog compound and an equimolar quantity of water.
C: Removing the water and solvent under reduced pressure, such as 10 mm Hg to obtain the solid alpha-carbon metalated toluene analog compound, which is best stored under hexane.

3. A method for producing polyphenylene paradimethylene comprising the steps of:
A: Dissolving parachloro toluene in a aprotic polar solvent in which the acidity of parachloro toluene is greater than that of water, such as DMSO at normal temperatures, under an inert atomosphere such as argon.
B: Adding an alkali metal hydroxide, such as sodium hydroxide, to form the alpha-carbon metalated parachloro toluene and an equimolar quantity of water.
C: Removing the water and solvent under reduced pressure, such as 10 mm Hg, to obtain the solid alpha-carbon metalated parachloro toluene.
D: Dissolving the alpha-carbon metalated parachloro toluene in a suitable high-boiling solvent such as dibutyl ether or dimethoxy ethane in the presence of a copper catalyst such as copper sulfate or finely divided copper metal and heating at 170C for 5 hours to produce polyphenylene paradimethylene and sodium chloride.
